(19) United States
(12) Patent Application Publication
(10) Pub. No.: US 2016/0330899 A1
(43) Pub. Date: Nov. 17, 2016

(54) ARRANGEMENT AND METHOD FOR DEEP SOIL PREPARATION

(71) Applicant: KVERNELAND GROUP OPERATIONS NORWAY AS, Kvernaland (NO)

(72) Inventors: Magne SKJÆVELAND, Klepp St. (NO); Sindre Kjeang MØRK, Lier (NO)

(73) Assignee: KVERNELAND GROUP OPERATIONS NORWAY AS, Kvernaland (NO)

(21) Appl. No.: 15/111,075

(22) PCT Filed: Jan. 7, 2015
(86) PCT No.: PCT/NO2015/050001

§ 371 Date: Jul. 12, 2016

(30) Foreign Application Priority Data
Jan. 16, 2014 (NO) 20140046

(51) Int. Cl. A01B 15/02; A01B 3/24; A01B 79/00

(52) U.S. Cl. CPC A01B 15/02; A01B 79/00; A01B 3/24

(57) ABSTRACT

An arrangement for the deep strip tillage of a soil (2) is disclosed, in which a secondary working element (11) includes one or more working element sections (111), a first working element section (111a) exhibiting a larger working depth than a primary working element (10) in a working position. A method of establishing strip-shaped, deep loose-soil channels (23) in a soil (2) arranged for storing water and receiving part of the root system of a vegetation is disclosed as well.

The invention relates to an arrangement and a method for the deep strip tillage of a soil.

In areas with low availability of moisture for the vegetation, the agricultural plant production is very much dependent on an efficient utilization of the limited, available amount of water, which the plants have at their disposal. In addition to there being little precipitation or low availability of water for artificial irrigation, the soil under the relatively shallow, tilled layer of soil is often hard and impenetrable to plant roots and water falling on the surface. This results in rainwater running off on the surface instead of being stored as groundwater, or evaporating from the upper, loose soil layer before the plants can make use of the water. In addition, the plant roots are not able to establish a root system deep enough for the deeper-lying groundwater to be utilized as a water source.

Broadly speaking, the loss of moisture through evaporation from the loose soil is in inverse ratio to the distance from the surface. Working the soil to a larger depth will generally create better conditions for the plants, as the roots may be established at a depth, which is less liable to losing moisture through evaporation. In addition, working the soil deeper will give a larger water storage volume over the hard, non-prepared soil. The drawback of deep soil tillage is that it is power-demanding and thereby unachievable in an agriculture not very much mechanized. Accordingly, it is a task in soil tillage to create a larger storage volume for water and the possibility of a deeper root system for the plants without the tilling of the soil becoming too power-demanding, but being achievable also with simple mechanization and limited tractive force available for the soil-working implements.

The invention has for its object to remedy or reduce at least one of the drawbacks of the prior art or at least provide a useful alternative to the prior art.

The object is achieved through features, which are specified in the description below and in the claims that follow.

An arrangement is provided for the deep, preferably multistage strip tillage of a soil, especially an oligotrophic and not very porous underground soil which is, to a substantial degree, impenetrable to water and plant roots, wherein the soil is worked by means of a primary working element and a secondary working element, the work being done in each stage, when the secondary working element includes several working element sections, to a larger depth than in the preceding stage by means of the secondary working element, the working element section of each new stage being arranged vertically below, but behind (seen in the direction of motion) the working element section of the preceding stage. The purpose of this is that, in each stage, work is being done in a limited depth of the non-tilled soil, so that the soil that lies right above a working element section can be broken loose and lifted up towards the surface without compacting the surrounding soil to any substantial degree or forcing open soil from an area substantially wider than the working element. It is an aim of the invention to bring the underground soil to the smallest possible degree up into an upper, eutrophic loose-soil layer, which constitutes a cultivation layer. It is also an aim to provide sufficiently deep, tilled portions with near-vertical side definitions towards the non-tilled soil. Such channel-shaped, deep-tilled portions are preferably arranged with regular spacing. A first stage may be a primary working element, which provides a shallow, continuous tilled surface layer, or this layer may be tilled with a following primary working element suitable therefor, possibly be formed from loose soil by said primary working element or further primary working elements. The surface layer prepared may typically be a flat seedbed for cereals, grass and so on or raised ridges or beds for row cultures like potatoes, vegetables and so on. Seeds or tubers for establishing a row culture may be placed in the area between the deep-tilled portions, also called loose-soil channels in what follows, or they may be placed right above the loose-soil channels. The channel depth is typically in the range of 40-60 cm counted from a plane surface.

Each working element section comprises a share arrangement forming the desired channel width. The share arrangement has a working angle which is large enough to ensure sufficiently good soil penetration, but at the same time so small that the vertical movement is limited as much as possible. A share angle lying in the range of 10-30 degrees will usually be adequate for the invention. The share arrangement may, with advantage, be arranged on a plate-shaped double shank, a first shank and a second shank being arranged at the side edges of the share arrangement and bordering the channel against the non-tilled soil and being joined together and attached at an upper portion to an implement frame or connected to a tractive element. A common, single shank, known from cultivators and harrows, for example, and formed with a rectangular or square, compact or hollow cross section, can be used as well. Alternatively, the shank may also project from an element on a main working element, for example from a beam on a plough, from a tine on a cultivator and so on. The plate shape gives sufficient strength and stability and, at the same time, gives the shank a limited transverse dimension in order thereby to prevent a front face of the shank from guiding underground soil up into the upper loose-soil layer to any substantial degree.

The vertical and horizontal spacing of the working element sections is typically the same or decreasing from the first stage to the last stage when the secondary working element is operative in a normal position.

When a soil-working implement is provided with several working elements according to the invention, it may be an advantage for each working element to be provided with a releasing device, preferably an automatically resettable releasing device, which provides for the working element to yield upwards when meeting extra strong resistance, for example stones or other earthfast bodies, so that the working depth of the implement as a whole is not affected to any degree worth mentioning. The advantage of an automatically resettable releaser is that it returns the working element to its normal working position after the obstacle has been passed.

In a first aspect, the invention relates more specifically to an arrangement for the deep strip tillage of a soil forming tilled channels in non-tilled soil, wherein a secondary working element including one or more working element sections, wherein, in a working position
a first partial working element exhibits a larger working depth than a primary working element, characterized in that
each working element section comprises a share arrangement arranged between plate-shaped first and second shanks, first and second shanks being attached to side edges of the share arrangement and forming borders between a loose-soil channel and a portion of the non-tilled soil, or
each working element section comprises a share arrangement held by a plate-shaped shank, said shank being attached to and projecting up from one of the side edges of the share arrangement and forming a border between a loose-soil channel and a portion of the non-tilled soil;
each working element section of the share arrangement forming the desired width of the channel.

Further working element sections may each exhibit a larger working depth than the preceding working element section, the working element sections exhibiting a horizontal spacing, viewed rearwards from the first working element section relative to the working direction of the secondary working element, and the centre lines of the working element sections being arranged in the same plane.

The secondary working element may be connected to the primary working element.

There may be a decreasing vertical distance from the first, upper working element section to the last, lower working element section.

The secondary working element may be provided with a releasing device. Alternatively, the releasing device may be automatically resettable.

The working angle of the share arrangement may lie in the range of 10-30 degrees.

In a second aspect, the invention relates more specifically to a method of establishing strip-shaped, deep loose-soil channels in a soil arranged to store water and receive parts of the root system of a vegetation, wherein the method includes the following steps:
tilling an upper loose-soil layer with a primary working element;
forming a strip-shaped loose-soil channel by extending the depth of the loose-soil channel in a stepped manner by moving a secondary working element through the soil, a first working element section exhibiting a larger working depth than a primary working element and loosening a first strip-shaped portion of the soil lying under said loose-soil layer, and following working element sections successively loosening further portions of the soil under the above-lying loose-soil channel formed, each working element section comprising a share arrangement arranged between plate-shaped first and second shanks, said first and second shanks being attached to side edges of the share arrangement, or each working element section comprising a share arrangement held by a plate-shaped shank, said shank being attached to and projecting up from one of the side edges of the share arrangement, characterized in that the method includes the further step:
immediately supporting a portion of the soil towards the loose-soil channel with at least one of the shanks.

In what follows, an example of a preferred embodiment is described, which is visualized in the accompanying drawings, in which:

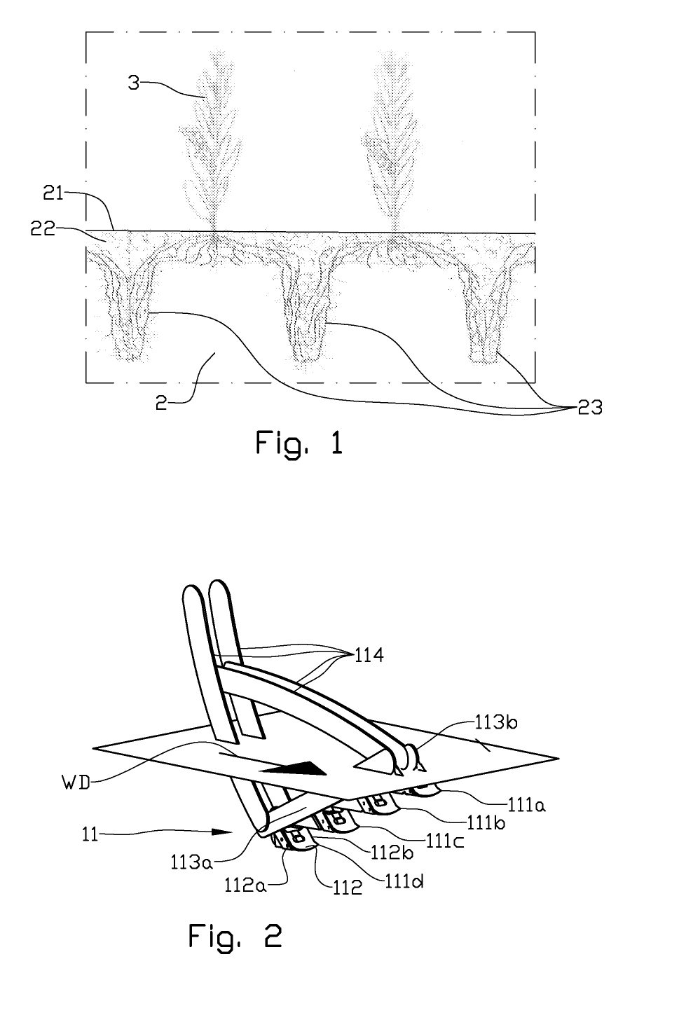

FIG. 1 shows a section through a soil transversely to the strip-shaped, deep loose-soil channels with an established vegetation;

FIG. 2 shows a principle drawing, in perspective, of a secondary working element according to the invention arranged to be mounted on a frame;

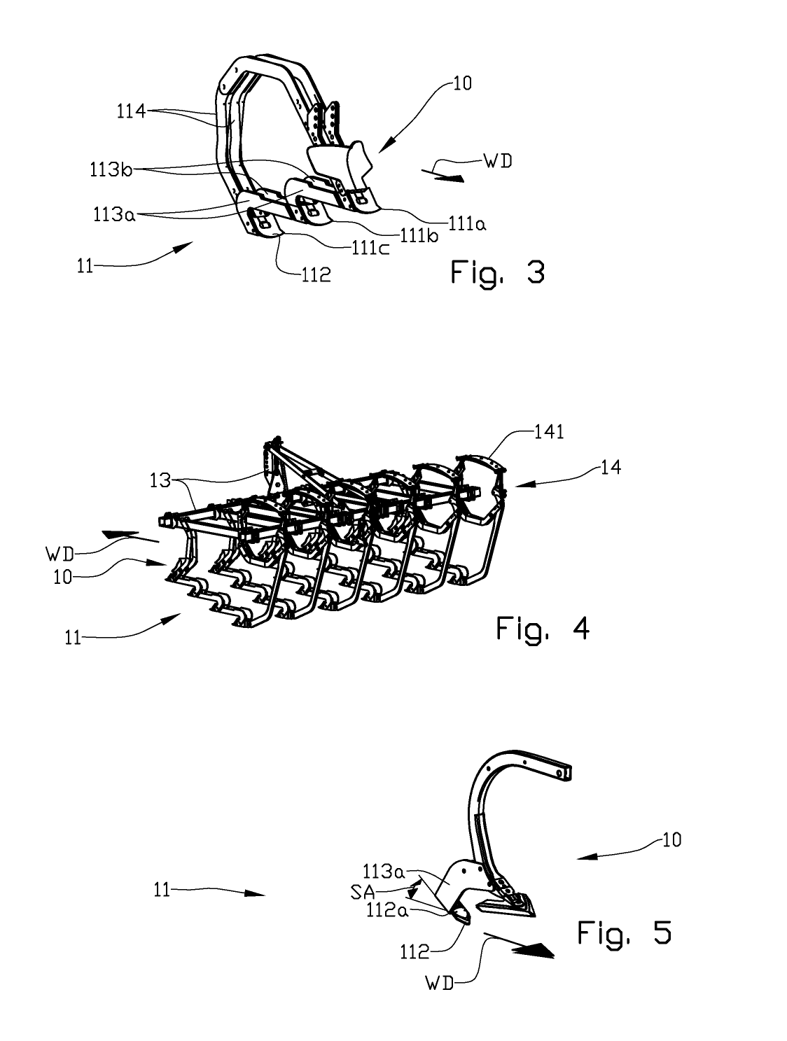

FIG. 3 shows the secondary working element in an alternative embodiment in an assembly with a primary working element, here in the form of a ridging share for moving an upper loose-soil layer;

FIG. 4 shows a soil-preparation implement on a smaller scale, provided with several primary and secondary working elements according to FIG. 2 assembled on an implement frame for mounting on a tractor, each secondary working element being provided with an automatically resettable releasing device; and

FIG. 5 shows a primary working member, on a larger scale, in the form of a cultivator tine provided with a secondary working element comprising one working element section in an alternative embodiment.

In FIG. 1, the reference numeral 2 indicates a non-tilled soil covered by an upper loose-soil layer 22 with a surface 21, which is formed according to the cultivation-technical demands made by a vegetation 3. Below the upper loose-soil layer 22, several parallel loose-soil channels 23 extend through the soil 2, substantially of the same shape and parallel. The loose-soil channels 23 provide both a porous, deep-lying volume for collecting water and a volume for quick and deep root development.

Reference is now made to FIG. 2, in which a secondary working element 11 is provided with four working element sections 111a, 111b, 111c, 111d arranged between first and second plate-shaped shanks 113a, 113b, the share arrangement 112 of each of the working element sections 111a, 111b, 111c, 111d being attached at its side edges 112a, 112b to the shanks 113a, 113b. Stay bars 114 extend from the end portions of the shanks 113a, 113b for the attachment of the secondary working element 11 to an implement frame 13 (see FIG. 4). The vertical distance between the working element sections 111a, 111b, 111c, 111d is decreasing from the upper working element section 111a to the lower working element section 111d. The working direction of the secondary working element 11 is indicated by an arrow WD. The share arrangement 112 has a working angle SA, see FIG. 5.

In FIG. 3 is shown an alternative embodiment of a three-share secondary working element 11 combined with a primary working element 10 in the form of a surface-forming share mounted in front of and above a first working element section 111a. The shanks 113a, 113b connecting the working element sections 111a, 111b, 111c are sectioned and extend between the share arrangements 112. Stay bars 114 project up from the front and rear working element sections 111a, 111c.

Reference is now made to FIG. 4, in which several four-share secondary working elements 11 and associated primary working elements 10 are arranged on an implement frame 13 for attachment to a tractor or the like. Each secondary working element 11 is provided with an automatically resettable releasing device 14, in which a pre-tensioned actuator is formed of a spring-leaf assembly 141.

In FIG. 5 is shown an alternative embodiment of a one-share secondary working element 11 arranged on a primary working element 10 in the form of a cultivator tine, a share arrangement 112 being attached to the primary working element 10 by means of only one shank 113a projecting up from one side edge 112a of the share arrangement 112 and thereby being placed to one side relative to the centre line of the share arrangement 112. The working angle of the share arrangement 112 is indicated by SA. This typically lies in the range of 10-30 degrees relative to the working direction WD of the secondary working element 11 and depends on the need for the soil-penetration capacity of the share arrangement 112, the hardness of the soil 2 and the need to prevent the soil of the loose-soil channel 23 from being carried up into the upper loose-soil layer 22, among other things.

For the preparation of a soil 2, an implement is adapted to the magnitude of the tractive power available. For simple operating conditions, an implement including one secondary working element 11 provided with connecting means, not shown, for a horse or another draught animal, and steering handles, not shown, for an operator may be provided. An implement pulled by a tractor may include many parallel secondary working elements 11, for example from 4-5 to about 20 secondary working elements 11. The spacing of the secondary working elements 11 is adapted to the need of the vegetation, which is going to be established, the characteristics of the traction unit and so on.

When the soil 2 is being tilled, the secondary working element 11 is lowered successively into the soil 2 while the implement is being pulled forwards. The share arrangements 112 each cut out a strip-shaped portion of the soil 2, forming a loose-soil layer, which is partially lifted up towards the surface 21. Because of the positioning of the working element sections 111a, 111b, 111c, 111d relative to each other and relative to the working direction of the implement, each share arrangement 112 will have a limited effective working depth in non-tilled soil 2, which reduces the overall power consumption and reduces the risk of the loose-soil channels 23 getting sloping side edges, that is to say a substantially V-shaped cross section. The arrangement according to the invention thereby enables a relatively deep strip tillage of soil, which is in need of a larger storage volume for water, an improved possibility of quick establishment of a deep root system for the vegetation, and drainage of an upper loose-soil layer to the ground-water storage of the underlying soil without any eroding surface run-off.

The embodiment according to FIG. 5 may have the advantage of the secondary working element 11 risking, to a smaller degree, becoming blocked by roots, stones and so on, as a single shank 113a lets such elements pass to a greater degree than two shanks 113a, 113b placed relatively tightly, as is shown in the FIGS. 2-4.

Letting one shank 113a project up from one side edge of the share arrangement 112, as has been done in the embodiment according to FIG. 5, has the advantage of the shank 113a preventing the flow of soil, which has been loosened by the share arrangement, to a lesser degree than a centred shank. The share arrangement 112 may still achieve sufficient support and stability by the lower portion of the shank 113a being L-shaped and extending in under the share arrangement 112.

1.-19. (canceled)

20. An arrangement for the deep strip tillage of a soil forming tilled channels in non-tilled soil, the arrangement comprising:
a primary working element; and
a secondary working element having one or more working element sections,
wherein a first working element section has a larger working depth than a working depth of the primary working element,
wherein each of the one or more working element sections includes a share arrangement arranged between plate-shaped first and second shanks, the first and second shanks being attached to side edges of the share arrangement and forming borders between a loose-soil channel and a portion of the non-tilled soil, or each of the working element sections includes a share arrangement held by a plate-shaped shank, the shank being attached to and projecting up from one of side edges of the share arrangement and forming a border between a loose-soil channel and a portion of the non-tilled soil,
wherein each of the one or more working element sections forms a desired width of the loose-soil channel.

21. The arrangement according to claim 20,
wherein a working depth of a subsequent working element section is larger than a working depth of the preceding working element section such that a working depth of the secondary working element increases from the first working element section to the last working element section,
wherein a horizontal spacing is provided between the one or more working element sections when viewed rearwards from the first working element section relative to a working direction of the secondary working element, and
center lines of each of the one or more working element sections are arranged in the same plane.

22. The arrangement according to claim 20, wherein the secondary working element is connected to the primary working element.

23. The arrangement according to claim 20, wherein a decreasing vertical distance is provided from the first working element section to the last working element section.

24. The arrangement according to claim 20, wherein the secondary working element is provided with a releasing device.

25. The arrangement according to claim 20, wherein the secondary working element is provided with an automatically resettable releasing device.

26. The arrangement according to claim 20, wherein a working angle of the share arrangement is in the range of 10 to 30 degrees.

27. A method for establishing strip-shaped, deep loose-soil channels in a soil arranged to store water and receive parts of a root system of a vegetation, the method comprising:
working an upper loose-soil layer with a primary working element;
forming a strip-shaped loose-soil channel by extending the depth of the loose-soil channel in a stepped manner by moving a secondary working element through the soil, the secondary working element comprising a first working element section that has a larger working depth than a working depth of the primary working element to loosen a first strip-shaped portion of the soil lying under the upper loose-soil layer, and following working element sections that successively loosen further portions of the soil under the first strip-shaped portion, each of the first working element section and the following working element sections having a share arrangement arranged between plate-shaped first and second shanks, the first and second shanks being attached to side edges of the share arrangement, or each of the first working element section and the following working element sections having a share arrangement held by a plate-shaped shank, the shank being attached to and projecting up from one of the side edges of the share arrangement; and
immediately supporting a portion of the soil towards the loose-soil channel with at least one of the shanks.
